(19) United States
(12) Patent Application Publication
(10) Pub. No.: US 2022/0215691 A1
(43) Pub. Date: Jul. 7, 2022

(54) UNCERTAINTY-AWARE GAIT ANALYSIS

(71) Applicant: Intel Corporation, Santa Clara, CA (US)

(72) Inventors: Neslihan KOSE CIHANGIR, Munich (DE); Rafael ROSALES, Unterhaching (DE); Akash DHAMASIA, Munich (DE); Yang PENG, Munich (DE); Michael PAULITSCH, Ottobrunn (DE)

(21) Appl. No.: 17/702,837

(22) Filed: Mar. 24, 2022

(51) Int. Cl. G06V 40/20; B25J 11/00; B25J 9/16; G08B 21/04; B25J 19/02

(52) U.S. Cl. CPC G06V 40/25; B25J 11/008; B25J 19/02; G08B 21/0423; G08B 21/0438; B25J 9/1674

(57) ABSTRACT

Disclosed herein are systems, devices, and methods for an uncertainty-aware robot system that may perform a personalized risk analysis of an observed person. The uncertainty-aware robot system determines a recognized behavior for the observed person based on sensor information indicative of a gait of the observed person. The uncertainty-aware robot system determines an uncertainty score for the recognized behavior based on a comparison of the recognized behavior to potentially expected behaviors associated with the observed person and the environment. The uncertainty-aware robot system generates a remedial action instruction based on the uncertainty score.

### TECHNICAL FIELD

This disclosure relates generally to robots that may interact with or observe human behavior, and in particular, to systems, devices, and methods for providing safe, reliable, and secure assistance to persons that may be in need of assistance.

### BACKGROUND

With the increase in the number of people needing social care (e.g., elderly people, chronically ill people, children with special needs, medical patients, etc.) and a decrease in the number of skilled care-givers to provide quality care, robots have become increasingly utilized for providing social/observational care. While social care robots may exist that interact with patients to provide companionship, offer entertainment, or assist with calls/appointments, such robots provide only limited assistance. Typically, these social care robots rely on direct interactions with or instructions from the human and then the robot may assist the human according to a preplanned routine that is responsive to the request. However, conventional robots may not be able to adjust to an abnormal situation, an unexpected interaction, or an unknown request. Moreover, because the responsive routines are typically fixed, they may not provide safe, reliable, or secure assistance that is adapted to the particular needs of the human or the particular aspects of the situation. Instead of personalized service, the robot may only execute a fixed routine that could be undesired, unsafe, or unsecure for the particular human and/or for the particular situation.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary uncertainty-aware robot system that may provide adaptable and personalized assistance;

FIGS. 2A and 2B show exemplary scenarios illustrating how an uncertainty-aware robot system may make a personalized, uncertainty-aware assessment;

FIG. 3 depicts an exemplary uncertainty-aware robot system that may provide adaptable and personalized assistance;

FIG. 4 depicts an exemplary uncertainty-aware robot system that may provide adaptable and personalized assistance;

FIG. 5 illustrates an exemplary schematic drawing of an uncertainty-aware robot device; and

FIG. 6 depicts an exemplary schematic flow diagram of a method for providing uncertainty aware, adaptable, and personalized assistance.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D) (Point™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “robot” may be understood to include any type of digitally controllable machine that is designed to perform a task or tasks. By way of example, a robot may be a vehicle; an autonomous mobile robot (AMR) that may move within an area (e.g., a manufacturing floor, an office building, a warehouse, a home, a medical facility, a clinic, a bedroom, etc.) to perform a task or tasks; or a robot may be understood as an automated machine with arms, tools, and/or sensors that may perform a task or tasks at a fixed location; or any combination thereof. In addition, reference may be made herein to a “human,” a “person,” or a “patient” that may be observed by or interact with a robot.

While social care robots may exist that interact with patients to provide companionship, offer entertainment, or assist with calls/appointments, they provide only limited assistance. For example, social robots are known that may be employed in social care facilities like nursing homes, elder-care facilities, rehabilitation centers, senior centers, etc., that assist patients by performing a variety of physical and social assistance tasks. These robot-performed tasks are typically responsive to a request from the patient, usually in the form of a command provided to the robot from the patient (e.g., by an audible request, selecting a choice on an application/screen, entering a request onto a keyboard/data-entry device, or reading the lips/face of the patient with respect to the desired command). In this sense, the robot may be considered a companion with whom the patient it conversing, for example a “chatbot” that mimics human-to-human communication for companionship or therapy. Based on the conversations, the chatbot may analyze the mood of the patient, conduct cognitive behavioral therapy, offer guidance on emotional states, answer questions, make appointments, offer entertainment options, provide cognitive exercises and other brain-boosting activities, etc.

Other robots are known that may perform physical assistance based on conversations with the person. For example, if a patient is in a bed and requests help to get out of bed, the robot may respond by physically assisting the patient from the bed to a standing position. As another example, in response to a request for cooking help in the kitchen, the robot may respond by performing the requested cooking-related task of opening a can, chopping vegetables, reaching into a high cabinet, etc. Other robots may perform retrieval tasks by responding to requests to collect and deliver food, medicine, or drinks. Other robots may provide routine reminders, instruct a patient on how to use a piece of equipment, call an emergency service in response to an emergency request, put the patient in contact with a requested medical provider, etc. Each of these conventional social care robots simply respond to requests from the serviced person/patient, requiring an interaction between robot and person/patient (e.g., usually in the form of a voice command, keyboard command, mouse selection, recognized instruction gestures, etc. from the person/patent). In addition, the robots' responses are generally not personalized to the person/patient making the request. Instead, the robots' extent of “personalization” tends to be methods for better understanding the request from the person/patient (e.g., learning a person/patient's unique speech patterns, instructional gestures, way of speaking, etc.).

As should be apparent from the detailed disclosure below, the disclosed uncertainty-aware robot system may provide an adaptable, secure, and personalized assistance solution by using active and uncertainty-aware gait monitoring of persons/patients who may need assistance. The disclosed uncertainty-aware robot system may personalize its safety response based on a personalized uncertainty-aware gait analysis/monitoring and human behavior understanding without relying on interactions with the person/patient and without relying on commands from the person/patient. Instead, the uncertainty-aware robot system may determine the optimal response based on observations that are made at a greater distance from the patient and without receiving a request for assistance. The disclosed uncertainty-aware robot system may be able to detect safety-critical abnormal situations, even when the patient may not be aware of the need for assistance, by analyzing the irregular nature of a gait pattern using uncertainty estimation that is specific to the monitored patient. In addition, the disclosed uncertainty-aware robot system may provide safe assistance by estimating the risk level of the identified situation and adapting its responsive operations according to the estimated risk level. Such an adaptable and personalized uncertainty-aware robot system may be particularly useful in providing safe assistance to persons/patients in healthcare facilities, nursing homes, elder-care facilities, rehabilitation centers, senior centers, etc.

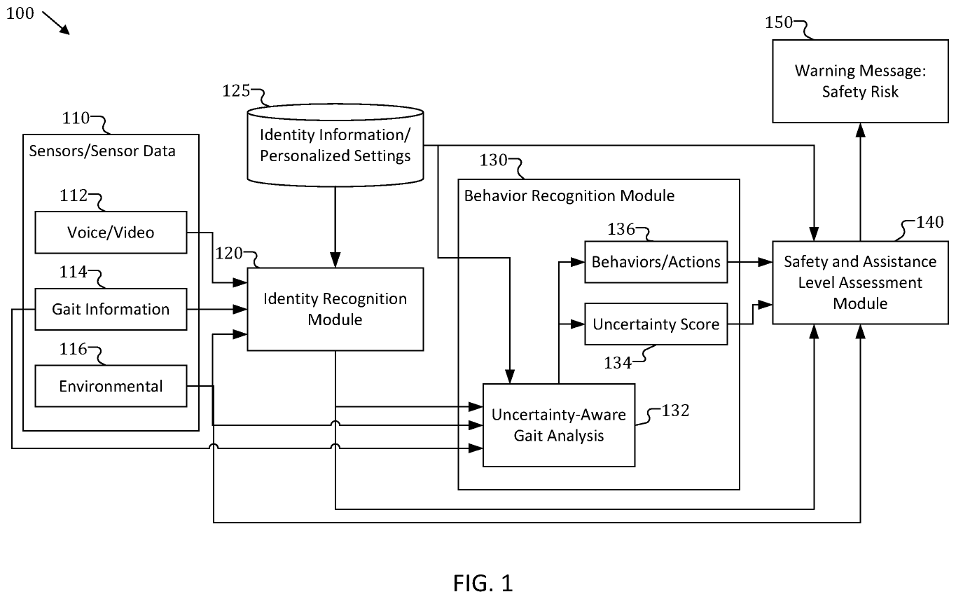

FIG. 1 shows an uncertainty-aware robot system 100 that may provide adaptable and personalized assistance to persons/people who may need assistance. Uncertainty-aware robot system 100 may use active gait monitoring to capture information about the person's movements, the environment, etc., even when the person is not nearby or instructing/interacting with the robot. Using an uncertainty-aware approach to gait-information, the uncertainty-aware robot system 100 may be able to more effectively identify critical/dangerous situations and adapt the responsive behaviors to the monitored persons/people based on the estimated level of risk.

The uncertainty-aware robot system 100 may include an identity recognition module 120 that may determine an identity of an observed person based on sensor data 110. Sensor data 110 may include data from sensors observing the person and the individual's environment, where the sensor data 110 may include, as non-limiting examples, voice/video data (e.g., 112), picture data, video data, information about the gait of the observed person (e.g., 114), environmental information (e.g., 116), or any other data about the observed person and/or environment. Sensor data 110 may be received from any number of sensors, including, for example, cameras, microphones, video equipment, motion detectors, seismic sensors, lasers, radar, light ranging and detector (LiDAR) sensors, gyroscopic sensors, accelerometers, environmental sensors, etc., or may be received from systems or robots that have collected the data. As should be appreciated, sensor data 110 may be received (e.g., via a receiver/transmitter) from any type of sensor, and the sensor may be part of uncertainty-aware robot system 100, remote to uncertainty-aware robot system 100, and/or distributed among any number of sensors and any number of sensing locations.

The identity recognition module 120 may use the sensor data 110 to determine the identity of the observed person using any number of modalities and may determine identity using one or more different streams (e.g., 1 modality, 2 different modalities, 3 different modalities, etc.), where if multiple streams are used, each stream may be used as a check/comparison to the other stream for checking/improving identification accuracy. For example, one stream may use a classic identification modality, including, for example, facial recognition, speech recognition, password recognition, token confirmation, etc. A second stream may use a gait-based technique to determine the identity. A gait-based analysis may be able to determine a vast amount of information about the observed person in terms of their unique identity as well as membership in a classification group such as their age or age range, their gender, whether they are mobility-impaired, their body shape, their body height, their body weight, etc. The gait-based analysis may also be able to determine a behavior of the observed person. A behavior may include a behavioral classification about the movement of the person, including, for example, whether the person is running, walking, jumping, skipping, dragging their feet, etc.; whether the person is slouching, attentively erect, moving in a relaxed manner, moving in a stressed manner; and any number of other behaviors. As such, a gait-based analysis in the identity recognition module 120 may provide rich information about the observed person that may be used to identify and classify the observed person by, for example, comparing the observed identity information and associated information about the observed person to historical/known information, e.g., retrieved from an identity information/personalized settings database 125 (e.g., a model of behaviors stored in a memory/database). To identify persons, the model may be a learning model that may be used to improve the identification of the person over time. The learning model may, for example, store gaits for the person that have been observed over time, such that the historical observations of the person's gait may be used to identify the currently observed person.

In addition, the identity information/personalized settings database 125 may include historical information about human behavior generally (e.g., how people may slow their gait when tired, how people may droop their head when not paying attention, how people may limp when they have an injured leg, etc.), and/or historical information specific to the identified person's behaviors (e.g., how this particular person tends to slouch when tired, how this particular person tends to move their head from left to right when distracted, how this particular person may stiffen their knees when they have an injured leg, etc.). Individualized information may be important because each particular person may have their own unique walking style, and different persons may adjust their walking styles differently when encountering the same set of circumstances or conditions. For example, one person may walk slower when tired whereas another person may walk faster when tired. As another example, it may be normal for an elderly person to slow down when ascending stairs, but it may be unusual for a young person, who usually bounds up the stairs two steps at a time, to slow down when ascending stairs. While historical information specific to the identified person's behaviors is not necessary, such historical information on the target identity's behaviors may assist, as discussed in more detail below, a behavior recognition module 130 in arriving at an accurate estimation of the expected behaviors and whether the person is actually in need of assistance or whether the person is responding normally to a given situation.

Once the identity recognition module 120 has identified the observed person, it may provide the identity of the person and any of the associated observations (e.g., gender, age, etc.) along with any of the personalized settings associated with that person (e.g., from the identity information/personalized settings database 125) to a behavior recognition module 130. The behavior recognition module 130 may perform an uncertainty-aware gait analysis 132 to determine expected behaviors/actions 136 (e.g., potentially expected behaviors) and/or an uncertainty score 134 associated with those expected behaviors/actions 136. The uncertainty-aware gait analysis 132 may also receive sensor data (e.g. from sensors/sensor data 110) that may include observed gait information 114 and environmental information 116 (e.g., a map of the environment around the observed person).

For the uncertainty-aware gait analysis 132, the behavior recognition module 130 may use a spatial-temporal gait analysis to recognize human actions and behaviors and estimate expected behaviors/actions 136. Using the sensor data, and in particular the observed gait information 114 and the environmental information 116, as well as the information provided by the identification recognition and historical information from the identity information/personalized settings database 125, the behavior recognition module 130 may estimate the potentially expected behaviors/actions of the person. As noted above, each person may have a unique walking style and different people may behave differently under the same conditions (e.g., one person may start walking very slowly when he/she is tired whereas another person may walk faster when he/she is tired), so the identity and historical information of the identified person's behaviors may be helpful information for the behavior recognition module 130 to use for accurately estimating the expected behaviors/actions 136 for a particular person in a particular situation. To determine potentially expected behaviors, the behavior recognition module 130 may use a model (e.g., a learning model) that may be used to improve the determination of potentially expected behaviors for the person over time. The learning model may, for example, store gaits for the person that have been observed over time, such that the historical observations of the person's gait may be used to determine the potentially expected behaviors from current observations.

The behavior recognition module 130 may also determine, as part of the uncertainty-aware gait analysis 132, an uncertainty score 134 associated with the expected behaviors/actions 136. The uncertainty score 134 may be particularly useful in identifying safety-critical scenarios. For example, the uncertainty score 134 may be higher for a behavior that the behavior recognition module 130 has not yet observed or has only observed on a limited basis compared to more common behaviors. The behavior recognition module 130 may base the uncertainty score 134 on the extent of irregularity of the gait compared to an expected gait pattern (e.g., the extent of change from an expected behavior) by comparing the uncertainty score 134 to a predetermined uncertainty threshold value, as shown in the exemplary formula:

f_{uncertainty score}(actual gait pattern)>f_{threshold}(identity;reference gait pattern)

If the above condition is met, it implies an irregularity to the gait pattern and therefore a potentially unsafe situation. In other words, if the uncertainty score for an observed behavior is higher than the threshold, this may indicate the detection of an abnormal behavior. As a consequence of detecting abnormal behavior, the uncertainty-aware robot system 100 may also adjust its own processing based on this uncertainty score. For example, the uncertainty-aware robot system 100 may adapt the path planning algorithms for the robot's movements so that the robot has an increased safety margin (e.g., distance) to the person or so that the robot operates at a reduced speed.

After the behavior recognition module 130 has determined the expected behaviors/actions 136 and associated uncertainty score(s) 134, the uncertainty-aware robot system 100 may provide this information, along with the environmental information 116 and information from the identity recognition module 120 (e.g., identity, gender, age, etc. and other associated information from the identity information/personalized settings database 125) to a safety and assistance level assessment module 140 that estimates the risk level of the situation based on this information. The safety and assistance level assessment module 140 may determine the risk level based on a personalized approach, meaning that the safety of the situation is determined based on the particular identity of the observed person (which may also include specific attributes such as age, gender, etc.) and according to the particular behavior. Because each particular behavior may be associated with its own uncertainty score for the particular behavior, the safety and assistance level assessment module 140 may determine the risk level based on each uncertainty score.

For example, in a manufacturing environment, the uncertainty-aware robot system 100 may recognize the identity of a person who generally climbs up a set of stairs on the manufacturing line within 1 minute, but if in this particular situation this person takes 3 minutes to perform this behavior, the uncertainty score(s) 134 may be high for this behavior for this person in this situation, and the safety and assistance level assessment module 140 may determine a high risk level. If the risk level exceeds a predetermined risk threshold, the uncertainty-aware robot system 100 may issue a warning message 150 that there is a safety risk. The warning message may be, for example, an instruction for others to provide physical assistance to the person, an instruction for the robot to move closer to the person, an instruction for the person to take a rest break, etc. On the other hand, if the uncertainty-aware robot system 100 recognizes the identity of a person who generally climbs up the same set of stairs on the manufacturing line within 5 minutes, and if this person takes 3 minutes to perform this behavior, the uncertainty score(s) 134 may be low for this behavior for this person in this situation, and the safety and assistance level assessment module 140 may determine a low risk level without the need to issue a warning message 150. In this sense, the uncertainty-aware robot system 100 may provide personalized assistance that has been tailored to the specific needs of the specific person.

By utilizing this information, the uncertainty-aware robot system 100 may advantageously provide more accurate responses to a given situation as compared to conventional robot systems. For example, a conventional system may recognize that a person is beginning to slip while walking down the stairs and provide assistance or issue a safety warning in response to the slip detection. This response, however, may be incorrect for a particular person who usually playfully slides down the stairs that may be misunderstood as slipping. Unlike the conventional systems, the uncertainty-aware robot system 100 may recognize the identify of this particular person and determine a low uncertainty score associated with this type of slipping behavior, and determine that the safety of the situation presents a low risk level. As another example, a conventional system may fail to recognize a dangerous situation, where, for example, a pregnant person is walking at a normal speed through a slippery environment. While the normal speed may be safe for persons who are not pregnant, the uncertainty-aware robot system 100 may recognize the identity of this particular person, that the person is pregnant, and that this pregnant person usually walks over slippery surfaces at a slower than normal speed. Based on this information, the uncertainty-aware robot system 100 may determine a high uncertainty score, and then determine that the safety of this particular situation for this particular person presents a high risk level.

In this manner, the uncertainty-aware robot system 100 may estimate the risk level for this particular situation and for this particular person so that it may more accurately determine the proper responsive action (e.g., to make an emergency call, to generate message with the correct remedial action instruction, to offer or to refrain from offering physical-assistance, etc.). As should be appreciated, the uncertainty-aware robot system 100 may use a rules-based system for determining uncertainty score and risk level, based on a combination of criteria based on the information observed about the person, including identity, gait, other demographics, and other environmental/locational information. Without limitation, the pseudocode below provides an example of how such a rules-based system may be structured:

```
human_behavior = HUMAN_GAIT_ANALYZER (gender, age, identity)
duration = DURATION (human_state)
location = LOCATION (human_state)
uncertainty = UNCERTAINTY_ANALYZER (location, human_behavior,
duration, age)
  if (location == CRITICAL_LOC) and (human_behavior == CRITICAL) and
  (duration == LONG) and (age >= AGE_THRESHOLD)
    then uncertainty = HIGH
    else uncertainty = LOW
  endif
assessment_level = ROBOT_ACTION_SELECTOR (uncertainty, human_behavior,
location, identity)
  if (uncertainty == HIGH) and (human_behavior == CRITICAL) and
  (identity == John) and (location == CRITICAL_LOC)
    then assessment_level = ROBOT_ACTION_1
    else assessment_level = NOTHING
  endif
```

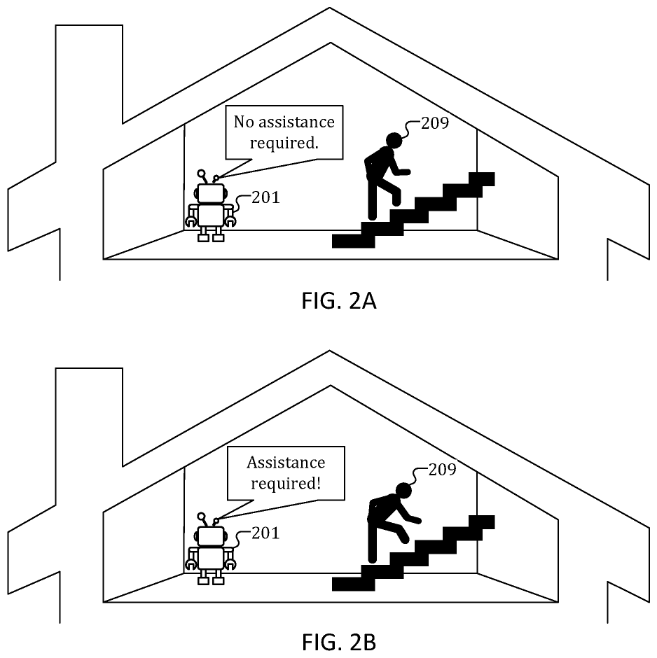

FIGS. 2A and 2B show exemplary scenarios to illustrate how an uncertainty-aware robot system such as uncertainty-aware robot system 100 may make a personalized, uncertainty-aware assessment of a given situation. In FIG. 2A for example, robot 201 may passively observe the behaviors of person 209 (e.g., obtained from sensors on the robot or within the room), who is currently walking up the stairs. The robot 201 may recognize the identity of the person 209 through a gait analysis. The robot 201 may also recognize the behavior (e.g., climbing stairs slowly) and determine an uncertainty score associated with this behavior. In this example, the identity may be of an elderly man who typically climbs this set of stairs safely using very slow movements with shaky arms. The robot 201 may determine, based on a comparison of the actual behavior to historical information for this person, that the uncertainty score is low and therefore the risk level is also low. Because the risk level does not exceed the pre-determined threshold level for a critical risk, the robot 201 determines that no assistance is required and no remedial action is necessary.

FIG. 2B shows a different time when robot 201 may be observing the same person 209, again climbing stairs slowly. This time, however, the robot 201 observes that the person 209 has a different than usual posture while lifting the left leg, and this type of movement is not expected when this person slowly climbs the stairs. The robot 201 may determine a high uncertainty score associated with this behavior and a high risk level that exceeds the pre-determined threshold level for a critical risk. As such, the robot 201 determines that assistance is required and a remedial action is necessary. Through the use of the uncertainty-aware gait analysis, the person 209 does not need to provide a command to the robot 201 or otherwise instruct the robot 201 to provide assistance. Indeed, the person 209 may be unaware of his/her change in posture, but robot 201 may nevertheless be able to detect a dangerous situation.

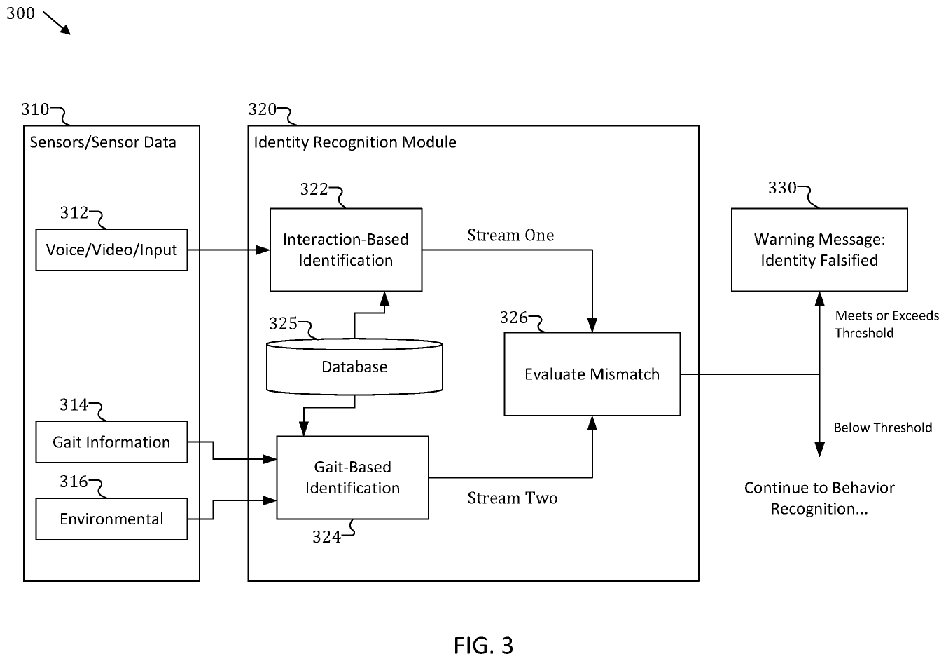

FIG. 3 shows an example of an uncertainty-aware robot system 300 that may provide adaptable and personalized assistance to persons/people who may need assistance. Without limitation, the uncertainty-aware robot system 300 may implement any, some, and/or all of the features described above with respect to uncertainty-aware robot system 100 and FIGS. 1, 2A, and 2B, including identity recognition module 120. It should be appreciated that uncertainty-aware robot system 300 is merely exemplary, and this example is not intended to limit any part of uncertainty-aware robot system 100, including identity recognition module 120, which may be implemented in any number of ways.

Identity recognition module 320 may include multi-stream identity recognition (e.g. multiple modalities) to determine whether an identity is being falsified (e.g., in a spoofing attack that intentionally misrepresents someone's identity). One stream of identity recognition may include an interaction-based recognition module 322 and a second stream of identity recognition may include a gait-based identification module 324. In the first stream, the interaction-based recognition module 322 may determine the identity of an observed person using conventional identity methods, including, as examples, voice-recognition, face-recognition, password input, gesture input, etc. For example, sensors/sensor data 310 may provide voice, video, and/or other types of input/interactive data (e.g., voice/video/input data 312) to the identity recognition module 320 that the interaction-based identification module 322 may use it to determine the observed person's identity (e.g., by comparing to interaction-based identification data that has been stored in a database 325). In the second stream, the gait-based identification may determine the identity of the observed person using gait analysis. For example, sensors/sensor data 310 may provide gait information 314, environmental information 316, and/or other types of observational data to the identity recognition module 320, which gait-based identification module 324 may use to determine the observed person's identity based on gait analysis.

Next, the identity recognition module 320 may evaluate the mismatch, in module 326, between the identity determined from the interaction-based identification module 322 (e.g., the first stream) to the identity determined from the gait-based identification module 324 (e.g., the second stream). If there is a sufficient mismatch between the two streams (e.g., the mismatch meets or exceeds a predetermined spoofing threshold), then the uncertainty-aware robot system 300 may determine that the identity was falsified and issue, in 330, an appropriate warning and/or instruction. If the two streams result in the same identity (e.g., the mismatch is below the predetermined spoofing threshold), then the uncertainty-aware robot system 300 may continue to perform behavior recognition and may make a safety and assistance level assessment in the manner discussed above with respect to uncertainty-aware robot system 100 (e.g., in behavior recognition module 130 and/or safety and assistance level assessment module 140).

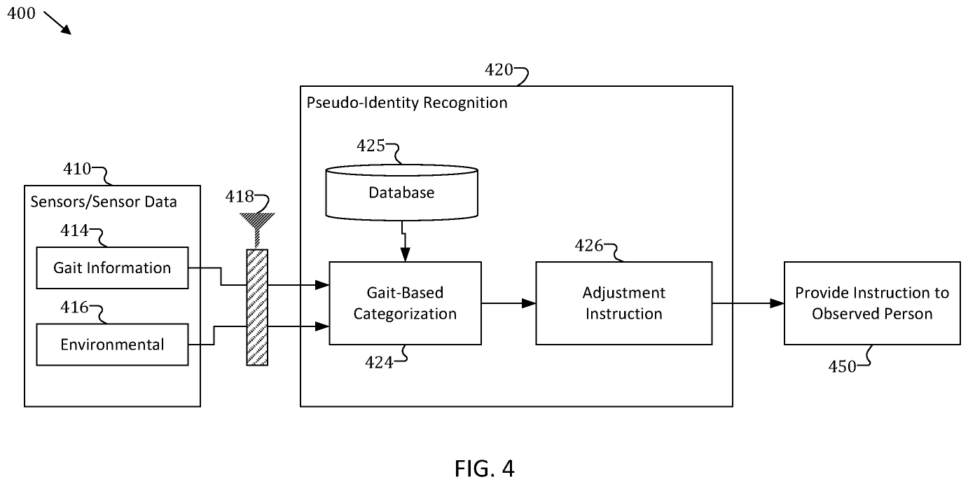

FIG. 4 shows an example of an uncertainty-aware robot system 400 that may provide adaptable and personalized assistance to persons/people who may need assistance. Without limitation, the uncertainty-aware robot system 400 may implement any, some, and/or all of the features described above with respect to uncertainty-aware robot system 100, uncertainty-aware robot system 300, and FIGS. 1, 2A-2B, and 3. It should be appreciated that uncertainty-aware robot system 400 is merely exemplary, and this example is not intended to limit any part of uncertainty-aware robot system 100 or uncertainty-aware robot system 300.

Uncertainty-aware robot system 400 may provide categorical assistance to a person based on a gait-based categorization of the person. For example, the sensors/sensor data 410 (e.g., gait information 414, environmental information 416, and other data such as images, video, etc.) may be filtered by an anonymization filter 418 so that personal/private information is removed. Once the personal/private information is removed, this anonymized information may be received by a pseudo-identity recognition module 420. Rather that determining the exact (e.g., unique) identity of a person, the pseudo-identity recognition module 420 may use the anonymized information, including for example anonymized gait information, to perform gait-based categorization 424 of the observed person. In this sense, the pseudo-identity recognition module 420 only determines a “pseudo-identity” from the gait information instead of the actual, unique identity.

The pseudo-identity may be classification(s) of the observed person, e.g., as a member in certain class category(s). Class categories may be stored (e.g., in a memory and/or in database 425) and may include, for example, classes for age (e.g., young, middle-age, senior, etc.), classes for gender, classes of energy levels (e.g., low energy, moderately active, energetic, distracted, etc.), classes of health (e.g., physically fit, degraded performance, health issue, health emergency, etc.), classes of body geometry (e.g., height ranges, weight ranges, etc.), and/or any other type or combination of categorization(s). Based on the gait-based categorization(s), the uncertainty-aware robot system 400 may generate an adjustment instruction 426 that provides assistance to the observed person relating to their gait-based categorization(s), for example, providing instructions for improved posture, providing movement exercises to improve energy levels, providing rest time periods for improving degraded performance, to adjust movements to avoid collisions, etc. The uncertainty-aware robot system 400 may then provide, in 450, the adjustment instruction 426 to the observed person or to other machines/robots with whom the observed person may be interacting.

As should be appreciated, an uncertainty-aware robot system 400 that provides assistance based on a gait-based categorization of the observed person may be useful on a manufacturing floor, for example, where workers may be interacting with machines and robots. As the worker approaches a workstation, for example, the uncertainty-aware robot system 400 may be able to observe the gait of the person and perform pseudo-identity recognition to categorize the observed person from their gait, and then customize the workstation or provide personalized assistance to the working according to the determined categorization(s). Existing security cameras or other existing sensors within the manufacturing facility may provide the sensor/sensor data 410 for uncertainty-aware robot system 400, making the implementation easy to install in manufacturing facilities with existing camera/sensor equipment.

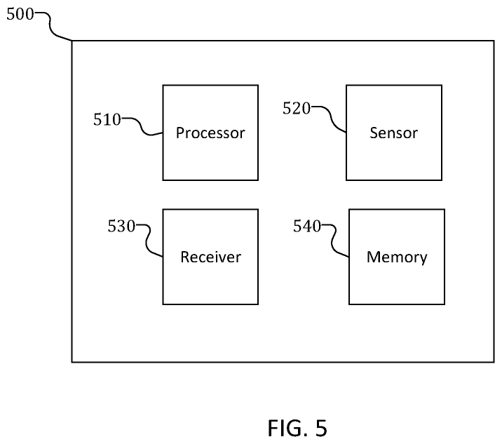

FIG. 5 is a schematic drawing illustrating a device 500 that may provide uncertainty aware, adaptable, and personalized assistance to persons/people who may need assistance. The device 500 may include any of the features discussed above with respect to uncertainty-aware robot system 100, uncertainty-aware robot system 300, uncertainty-aware robot system 400, and FIGS. 1, 2A-2B, 3, and 4. FIG. 5 may be implemented as a device, a system, a method, and/or a computer readable medium that, when executed, performs the features of the robot safety systems described above. It should be understood that device 500 is only an example, and other configurations may be possible that include, for example, different components or additional components.

Device 500 includes a processor 510 that is configured to determine a recognized behavior for an observed person based on sensor information indicative of a gait of the observed person. In addition to or in combination with any of the features described in this or the following paragraphs, processor 510 is further configured to determine an uncertainty score for the recognized behavior based on a comparison of the recognized behavior to potentially expected behaviors associated with the observed person. In addition to or in combination with any of the features described in this or the following paragraphs, processor 510 is further configured to generate a remedial action instruction based on the uncertainty score.

Furthermore, in addition to or in combination with any one of the features of this and/or the preceding paragraph with respect to device 500, the processor 510 may be further configured to determine the comparison based on a model for the potentially expected behaviors. Furthermore, in addition to or in combination with any one of the features of this and/or the preceding paragraph, the processor 510 may be further configured to determine the potentially expected behaviors based on an identity of the observed person. Furthermore, in addition to or in combination with any one of the features of this and/or the preceding paragraph, the processor 510 may be further configured to determine an identity of the observed person based on the gait of the observed person. Furthermore, in addition to or in combination with any one of the features of this and/or the preceding paragraph with respect to device 500, the comparison may be based on the identity of the observed person. Furthermore, in addition to or in combination with any one of the features of this and/or the preceding paragraph with respect to device 500, the identity may include a unique identity of the observed person.

Furthermore, in addition to or in combination with any one of the features of this and/or the preceding two paragraphs with respect to device 500, the identity may include a categorical identity of the observed person, wherein the categorical identity describes a category in which the observed person belongs. Furthermore, in addition to or in combination with any one of the features of this and/or the preceding two paragraphs with respect to device 500, the category may include at least one of an age group, a gender group, a health level group, an energy level group, a body height group, a body weight group, or a body geometry group. Furthermore, in addition to or in combination with any one of the features of this and/or the preceding two paragraphs with respect to device 500, the uncertainty score may be based on whether the comparison exceeds a predetermined threshold for the recognized behavior. Furthermore, in addition to or in combination with any one of the features of this and/or the preceding two paragraphs with respect to device 500, the sensor information may be indicative of the gait of the observed person over a time period and/or a distance that the observed person moves.

Furthermore, in addition to or in combination with any one of the features of this and/or the preceding three paragraphs, the processor 510 may be configured to determine the recognized behavior based on a gait analysis of the sensor information as compared to historical gait information. Furthermore, in addition to or in combination with any one of the features of this and/or the preceding three paragraphs with respect to device 500, the remedial action instruction may be further based on a risk level associated with the recognized behavior. Furthermore, in addition to or in combination with any one of the features of this and/or the preceding three paragraphs, the processor 510 may be further configured to determine the risk level based on the gait of the observed person and/or the uncertainty score. Furthermore, in addition to or in combination with any one of the features of this and/or the preceding three paragraphs, the processor 510 may be further configured to determine the risk level based on map data indicative of an environment of the observed person. Furthermore, in addition to or in combination with any one of the features of this and/or the preceding three paragraphs, the processor 510 is further configured to determine the risk level based on an identity of the observed person.

Furthermore, in addition to or in combination with any one of the features of this and/or the preceding four paragraphs with respect to device 500, the remedial action instruction may include an emergency call instruction, a message display instruction, and/or a robotic movement instruction. Furthermore, in addition to or in combination with any one of the features of this and/or the preceding four paragraphs, the processor 510 may be further configured to receive identification information about the observed person, determine an expected identity of the observed person based on the gait, determine a deviation between the identification information and the expected identity, and generate an identity verification indicator that confirms the identification information if the deviation is below a predetermined threshold deviation level. Furthermore, in addition to or in combination with any one of the features of this and/or the preceding four paragraphs, the processor 510 may be further configured to generate an identity warning if the deviation meets or exceeds the predetermined threshold deviation level.

Furthermore, in addition to or in combination with any one of the features of this and/or the preceding five paragraphs, the device 500 may be a robot. Furthermore, in addition to or in combination with any one of the features of this and/or the preceding five paragraphs, the processor 510 may be further configured to receive the sensor information from one or more sensors 520. Furthermore, in addition to or in combination with any one of the features of this and/or the preceding five paragraphs, device 500 may include the one or more sensors 520. Furthermore, in addition to or in combination with any one of the features of this and/or the preceding five paragraphs, the one or more sensors 520 may be external to device 500 and device 500 may further include a receiver 530 configured to receive the sensor information from the one or more sensors 520. Furthermore, in addition to or in combination with any one of the features of this and/or the preceding five paragraphs, device 500 may further include a memory 540 configured to store the model of potentially expected behaviors. Furthermore, in addition to or in combination with any one of the features of this and/or the preceding five paragraphs.

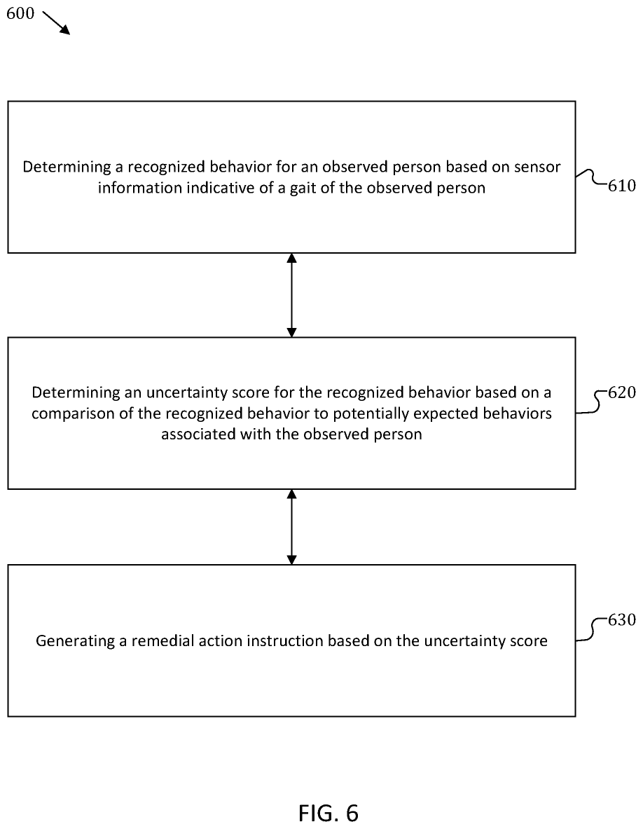

FIG. 6 depicts a schematic flow diagram of a method 600 for providing uncertainty aware, adaptable, and personalized assistance to persons/people who may need assistance. Method 600 may implement any of the features discussed above with respect to uncertainty-aware robot system 100, uncertainty-aware robot system 300, uncertainty-aware robot system 400, uncertainty-aware robot device 500, and FIGS. 1, 2A-2B, 3, 4, and 5.

Method 600 includes, in 610, determining a recognized behavior for an observed person based on sensor information indicative of a gait of the observed person. Method 600 also includes, in 620, determining an uncertainty score for the recognized behavior based on a comparison of the recognized behavior to potentially expected behaviors associated with the observed person. Method 600 also includes, in 630, generating a remedial action instruction based on the uncertainty score.

In the following, various examples are provided that may include one or more aspects described above with reference to uncertainty-aware robot system 100, 300, 400, uncertainty-aware robot device 500, method 600, and/or FIGS. 1-6. The examples provided in relation to the devices may apply also to the described method(s), and vice versa.

Example 1 is a device that includes a processor configured to determine a recognized behavior for an observed person based on sensor information indicative of a gait of the observed person. The processor is also configured to determine an uncertainty score for the recognized behavior based on a comparison of the recognized behavior to potentially expected behaviors associated with the observed person. The processor is also configured to generate a remedial action instruction based on the uncertainty score.

Example 2 is the device of example 1, wherein the processor is further configured to determine the comparison based on a model for the potentially expected behaviors.

Example 3 is the device of either of examples 1 or 2, wherein the processor is further configured to determine the potentially expected behaviors based on an identity of the observed person.

Example 4 is the device of any of examples 1 to 3, wherein the processor is further configured to determine an identity of the observed person based on the gait of the observed person.

Example 5 is the device of either of examples 3 to 4, wherein the comparison is based on the identity of the observed person.

Example 6 is the device of any of examples 3 to 5, wherein the identity includes a unique identity of the observed person.

Example 7 is the device of any of examples 3 to 6, wherein the identity includes a categorical identity of the observed person, wherein the categorical identity describes a category in which the observed person belongs.

Example 8 is the device of example 7, wherein the category includes at least one of an age group, a gender group, a health level group, an energy level group, a body height group, a body weight group, or a body geometry group.

Example 9 is the device of any one of examples 1 to 8, wherein the uncertainty score is based on whether the comparison exceeds a predetermined threshold for the recognized behavior.

Example 10 is the device of any one of examples 1 to 9, wherein the sensor information is indicative of the gait of the observed person over a time period and/or a distance that the observed person moves.

Example 11 is the device of any one of examples 1 to 10, wherein the processor is configured to determine the recognized behavior based on a gait analysis of the sensor information as compared to historical gait information.

Example 12 is the device of any one of examples 1 to 11, wherein the remedial action instruction is further based on a risk level associated with the recognized behavior.

Example 13 is the device of example 12, wherein the processor is further configured to determine the risk level based on the gait of the observed person and/or the uncertainty score.

Example 14 is the device of either of examples 12 or 13, wherein the processor is further configured to determine the risk level based on map data indicative of an environment of the observed person.

Example 15 is the device of any one of examples 12 to 14, wherein the processor is further configured to determine the risk level based on an identity of the observed person.

Example 16 is the device of any one of examples 1 to 15, wherein the remedial action instruction includes an emergency call instruction, a message display instruction, and/or a robotic movement instruction.

Example 17 is the device of any one of examples 1 to 16, wherein the processor is further configured to receive identification information about the observed person, determine an expected identity of the observed person based on the gait, determine a deviation between the identification information and the expected identity, and generate an identity verification indicator that confirms the identification information if the deviation is below a predetermined threshold deviation level.

Example 18 is the device of example 17, wherein the processor is further configured to generate an identity warning if the deviation meets or exceeds the predetermined threshold deviation level.

Example 19 is the device of any one of examples 1 to 18, wherein the device is a robot.

Example 20 is the device of any one of examples 1 to 19, wherein the processor is further configured to receive the sensor information from one or more sensors.

Example 21 is the device of example 20, wherein the device includes the one or more sensors.

Example 22 is the device of example 20, wherein the one or more sensors are external to the device, wherein the device further includes a receiver configured to receive the sensor information from the one or more sensors.

Example 23 is the device of example 2, the device further including a memory configured to store the model of potentially expected behaviors.

Example 24 is an apparatus that includes a processor configured to detect a gait of a person using a sensor. The processor is also configured to determine a behavior of the person based on the gait of the person. The processor is also configured to determine a comparison of the behavior to potentially expected behaviors associated with the person and an uncertainty score for the comparison. The processor is also configured to generate a remedial action instruction based on the comparison and the uncertainty score.

Example 25 is the apparatus of example 24, wherein the processor is further configured to determine the comparison based on a model for the potentially expected behaviors.

Example 26 is the apparatus of either of examples 24 or 25, wherein the processor is further configured to determine the potentially expected behaviors based on an identity of the person.

Example 27 is the apparatus of any one of examples 24 to 26, wherein the processor is further configured to determine an identity of the person based on the gait of the person.

Example 28 is the apparatus of either of examples 26 to 27, wherein the comparison is based on the identity of the person.

Example 29 is the apparatus of any one of examples 26 to 28, wherein the identity includes a unique identity of the person.

Example 30 is the apparatus of any one of examples 26 to 29, wherein the identity includes a categorical identity of the person, wherein the categorical identity describes a category in which the person belongs.

Example 31 is the apparatus of example 30, wherein the category includes at least one of an age group, a gender group, a health level group, an energy level group, a body height group, a body weight group, or a body geometry group.

Example 32 is the apparatus of any one of examples 24 to 31, wherein the uncertainty score is based on whether the comparison exceeds a predetermined threshold for the behavior.

Example 33 is the apparatus of any one of examples 24 to 32, wherein the sensor information is indicative of the gait of the person over a time period and/or a distance that the person moves.

Example 34 is the apparatus of any one of examples 24 to 33, wherein the processor is configured to determine the behavior based on a gait analysis of the sensor information as compared to historical gait information.

Example 35 is the apparatus of any one of examples 24 to 34, wherein the remedial action instruction is further based on a risk level associated with the recognized behavior.

Example 36 is the apparatus of example 35, wherein the processor is further configured to determine the risk level based on the gait of the observed person and/or the uncertainty score.

Example 37 is the apparatus of either of examples 35 or 36, wherein the processor is further configured to determine the risk level based on map data indicative of an environment of the observed person.

Example 38 is the apparatus of any one of examples 35 to 37, wherein the processor is further configured to determine the risk level based on an identity of the observed person.

Example 39 is the apparatus of any one of examples 24 to 38, wherein the remedial action instruction includes an emergency call instruction, a message display instruction, and/or a robotic movement instruction.

Example 40 is the apparatus of any one of examples 24 to 39, wherein the processor is further configured to receive identification information about the person, determine an expected identity of the person based on the gait, determine a deviation between the identification information and the expected identity, and generate an identity verification indicator that confirms the identification information if the deviation is below a predetermined threshold deviation level.

Example 41 is the apparatus of example 40, wherein the processor is further configured to generate an identity warning if the deviation meets or exceeds the predetermined threshold deviation level.

Example 42 is the apparatus of any one of examples 24 to 41, wherein the apparatus is a robot.

Example 43 is the apparatus of any one of examples 24 to 42, wherein the processor is further configured to receive the sensor information from one or more sensors.

Example 44 is the apparatus of example 43, wherein the apparatus includes the one or more sensors.

Example 45 is the apparatus of example 43, wherein the one or more sensors are external to the apparatus, wherein the apparatus further includes a receiver configured to receive the sensor information from the one or more sensors.

Example 46 is the apparatus of example 25, the apparatus further including a memory configured to store the model of potentially expected behaviors.

Example 47 is a method that includes determining a recognized behavior for an observed person based on sensor information indicative of a gait of the observed person. The method also includes determining an uncertainty score for the recognized behavior based on a comparison of the recognized behavior to potentially expected behaviors associated with the observed person. The method also includes generating a remedial action instruction based on the uncertainty score.

Example 48 is the method of example 47, the method further including determining the comparison based on a model for the potentially expected behaviors

Example 49 is the method of either of examples 47 or 48, the method further including determining the potentially expected behaviors based on an identity of the observed person.

Example 50 is the method of any of examples 47 to 49, the method further including determining an identity of the observed person based on the gait of the observed person.

Example 51 is the method of either of examples 49 to 50, wherein the comparison is based on the identity of the observed person.

Example 52 is the method of any of examples 49 to 51, wherein the identity includes a unique identity of the observed person.

Example 53 is the method of any of examples 49 to 52, wherein the identity includes a categorical identity of the observed person, wherein the categorical identity describes a category in which the observed person belongs.

Example 54 is the method of example 53, wherein the category includes at least one of an age group, a gender group, a health level group, an energy level group, a body height group, a body weight group, or a body geometry group.

Example 55 is the method of any one of examples 47 to 54, wherein the uncertainty score is based on whether the comparison exceeds a predetermined threshold for the recognized behavior.

Example 56 is the method of any one of examples 47 to 55, wherein the sensor information is indicative of the gait of the observed person over a time period and/or a distance that the observed person moves.

Example 57 is the method of any one of examples 47 to 56, the method further including determining the recognized behavior based on a gait analysis of the sensor information as compared to historical gait information.

Example 58 is the method of any one of examples 47 to 57, wherein the remedial action instruction is further based on a risk level associated with the recognized behavior.

Example 59 is the method of example 58, the method further including determining the risk level based on the gait of the observed person and/or the uncertainty score.

Example 60 is the method of either of examples 58 or 59, the method further including determining the risk level based on map data indicative of an environment of the observed person.

Example 61 is the method of any one of examples 58 to 60, the method further including determining the risk level based on an identity of the observed person.

Example 62 is the method of any one of examples 47 to 61, wherein the remedial action instruction includes an emergency call instruction, a message display instruction, and/or a robotic movement instruction.

Example 63 is the method of any one of examples 47 to 62, the method further including receiving identification information about the observed person, determining an expected identity of the observed person based on the gait, determining a deviation between the identification information and the expected identity, and generating an identity verification indicator that confirms the identification information if the deviation is below a predetermined threshold deviation level.

Example 64 is the method of example 63, the method further including generating an identity warning if the deviation meets or exceeds the predetermined threshold deviation level.

Example 65 is the method of any one of examples 47 to 64, the method further including receiving the sensor information from one or more sensors.

Example 66 is the method of example 48, the method further including storing the model of potentially expected behaviors in a memory.

Example 67 is a method that includes detecting a gait of a person using a sensor. The method also includes determining a behavior of the person based on the gait of the person. The method also includes determining a comparison of the behavior to potentially expected behaviors associated with the person and an uncertainty score for the comparison. The method also includes generating a remedial action instruction based on the comparison and the uncertainty score.

Example 68 is the method of example 67, the method further including determining the comparison based on a model for the potentially expected behaviors.

Example 69 is the method of either of examples 67 or 68, the method further including determining the potentially expected behaviors based on an identity of the person.

Example 70 is the method of any one of examples 67 to 69, the method further including determining an identity of the person based on the gait of the person.

Example 71 is the method of either of examples 69 to 70, wherein the comparison is based on the identity of the person.

Example 72 is the method of any one of examples 69 to 71, wherein the identity includes a unique identity of the person.

Example 73 is the method of any one of examples 69 to 72, wherein the identity includes a categorical identity of the person, wherein the categorical identity describes a category in which the person belongs.

Example 74 is the method of example 73, wherein the category includes at least one of an age group, a gender group, a health level group, an energy level group, a body height group, a body weight group, or a body geometry group.

Example 75 is the method of any one of examples 67 to 74, wherein the uncertainty score is based on whether the comparison exceeds a predetermined threshold for the behavior.

Example 76 is the method of any one of examples 67 to 75, wherein the sensor information is indicative of the gait of the person over a time period and/or a distance that the person moves.

Example 77 is the method of any one of examples 67 to 76, the method further including determining the behavior based on a gait analysis of the sensor information as compared to historical gait information.

Example 78 is the method of any one of examples 67 to 77, wherein the remedial action instruction is further based on a risk level associated with the recognized behavior.

Example 79 is the method of example 78, the method further including determining the risk level based on the gait of the observed person and/or the uncertainty score.

Example 80 is the method of either of examples 78 or 79, the method further including determining the risk level based on map data indicative of an environment of the observed person.

Example 81 is the method of any one of examples 78 to 80, the method further including determining the risk level based on an identity of the observed person.

Example 82 is the method of any one of examples 67 to 81, wherein the remedial action instruction includes an emergency call instruction, a message display instruction, and/or a robotic movement instruction.

Example 83 is the method of any one of examples 67 to 82, the method further including receiving identification information about the person, determining an expected identity of the person based on the gait, determining a deviation between the identification information and the expected identity, and generating an identity verification indicator that confirms the identification information if the deviation is below a predetermined threshold deviation level.

Example 84 is the method of example 83, the method further including generating an identity warning if the deviation meets or exceeds the predetermined threshold deviation level.

Example 85 is the method of any one of examples 67 to 84, the method further including receiving (e.g., via a receiver) the sensor information from one or more sensors.

Example 86 is the method of example 68, the method further including storing the model of potentially expected behaviors.

Example 87 is a device that includes a means for determining a recognized behavior for an observed person based on sensor information indicative of a gait of the observed person. The device also includes a means for determining an uncertainty score for the recognized behavior based on a comparison of the recognized behavior to potentially expected behaviors associated with the observed person. The device also includes a means for generating a remedial action instruction based on the uncertainty score.

Example 88 is the device of example 87, the device further including a means for determining the comparison based on a model for the potentially expected behaviors

Example 89 is the device of either of examples 87 or 88, the device further including a means for determining the potentially expected behaviors based on an identity of the observed person.

Example 90 is the device of any of examples 87 to 89, the device further including a means for determining an identity of the observed person based on the gait of the observed person.

Example 91 is the device of either of examples 89 to 90, wherein the comparison is based on the identity of the observed person.

Example 92 is the device of any of examples 89 to 91, wherein the identity includes a unique identity of the observed person.

Example 93 is the device of any of examples 89 to 92, wherein the identity includes a categorical identity of the observed person, wherein the categorical identity describes a category in which the observed person belongs.

Example 94 is the device of example 93, wherein the category includes at least one of an age group, a gender group, a health level group, an energy level group, a body height group, a body weight group, or a body geometry group.

Example 95 is the device of any one of examples 87 to 94, wherein the uncertainty score is based on whether the comparison exceeds a predetermined threshold for the recognized behavior.

Example 96 is the device of any one of examples 87 to 95, wherein the sensor information is indicative of the gait of the observed person over a time period and/or a distance that the observed person moves.

Example 97 is the device of any one of examples 87 to 96, the device further including a means for determining the recognized behavior based on a gait analysis of the sensor information as compared to historical gait information.

Example 98 is the device of any one of examples 87 to 97, wherein the remedial action instruction is further based on a risk level associated with the recognized behavior.

Example 99 is the device of example 98, the device further including a means for determining the risk level based on the gait of the observed person and/or the uncertainty score.

Example 100 is the device of either of examples 98 or 99, the device further including a means for determining the risk level based on map data indicative of an environment of the observed person.

Example 101 is the device of any one of examples 98 to 100, the device further including a means for determining the risk level based on an identity of the observed person.

Example 102 is the device of any one of examples 87 to 101, wherein the remedial action instruction includes an emergency call instruction, a message display instruction, and/or a robotic movement instruction.

Example 103 is the device of any one of examples 87 to 102, the device further including a means for receiving identification information about the observed person, a means for determining an expected identity of the observed person based on the gait, a means for determining a deviation between the identification information and the expected identity, and a means for generating an identity verification indicator that confirms the identification information if the deviation is below a predetermined threshold deviation level.

Example 104 is the device of example 103, the device further including a means for generating an identity warning if the deviation meets or exceeds the predetermined threshold deviation level.

Example 105 is the device of any one of examples 87 to 104, the device further including a means for receiving the sensor information from one or more sensing means.

Example 106 is the device of example 105, wherein the device includes the one or more sensing means.

Example 107 is the device of example 105, wherein the one or more sensing means are external to the device, wherein the device further includes a receiving means for receiving the sensor information from the one or more sensing means.

Example 108 is the device of example 88, the device further including a means for storing the model of potentially expected behaviors.

Example 109 is an apparatus that includes means for detecting a gait of a person using a sensor. The apparatus also includes a means for determining a behavior of the person based on the gait of the person. The apparatus also includes a means for determining a comparison of the behavior to potentially expected behaviors associated with the person and an uncertainty score for the comparison. The apparatus also includes a means for generating a remedial action instruction based on the comparison and the uncertainty score.

Example 110 is the apparatus of example 109, the apparatus further including a means for determining the comparison based on a model for the potentially expected behaviors.

Example 111 is the apparatus of either of examples 109 or 110, the apparatus further including a means for determining the potentially expected behaviors based on an identity of the person.

Example 112 is the apparatus of any one of examples 109 to 111, the apparatus further including a means for determining an identity of the person based on the gait of the person.

Example 113 is the apparatus of either of examples 111 to 112, wherein the comparison is based on the identity of the person.

Example 114 is the apparatus of any one of examples 111 to 113, wherein the identity includes a unique identity of the person.

Example 115 is the apparatus of any one of examples 111 to 114, wherein the identity includes a categorical identity of the person, wherein the categorical identity describes a category in which the person belongs.

Example 116 is the apparatus of example 115, wherein the category includes at least one of an age group, a gender group, a health level group, an energy level group, a body height group, a body weight group, or a body geometry group.

Example 117 is the apparatus of any one of examples 109 to 116, wherein the uncertainty score is based on whether the comparison exceeds a predetermined threshold for the behavior.

Example 118 is the apparatus of any one of examples 109 to 117, wherein the sensor information is indicative of the gait of the person over a time period and/or a distance that the person moves.

Example 119 is the apparatus of any one of examples 109 to 118, the apparatus further including a means for determining the behavior based on a gait analysis of the sensor information as compared to historical gait information.

Example 120 is the apparatus of any one of examples 109 to 119, wherein the remedial action instruction is further based on a risk level associated with the recognized behavior.

Example 121 is the apparatus of example 120, the apparatus further including a means for determining the risk level based on the gait of the observed person and/or the uncertainty score.

Example 122 is the apparatus of either of examples 120 or 121, the apparatus further including a means for determining the risk level based on map data indicative of an environment of the observed person.

Example 123 is the apparatus of any one of examples 120 to 122, the apparatus further including a means for determining the risk level based on an identity of the observed person.

Example 124 is the apparatus of any one of examples 109 to 123, wherein the remedial action instruction includes an emergency call instruction, a message display instruction, and/or a robotic movement instruction.

Example 125 is the apparatus of any one of examples 109 to 124, the apparatus further including a means for receiving identification information about the person, a means for determining an expected identity of the person based on the gait, a means for determining a deviation between the identification information and the expected identity, and means for generating an identity verification indicator that confirms the identification information if the deviation is below a predetermined threshold deviation level.

Example 126 is the apparatus of example 125, the apparatus further including a means for determining an identity warning if the deviation meets or exceeds the predetermined threshold deviation level.

Example 127 is the apparatus of any one of examples 109 to 126, the apparatus further including a means for receiving the sensor information from one or more sensing means.

Example 128 is the apparatus of example 127, wherein the apparatus includes the one or more sensing means.

Example 129 is the apparatus of example 127, wherein the one or more sensing means are external to the apparatus, wherein the apparatus further includes a receiving means for receiving the sensor information from the one or more sensors.

Example 130 is the apparatus of example 110, the apparatus further including a means for storing the model of potentially expected behaviors.

Example 131 is a non-transitory computer readable medium that includes instructions which, if executed, cause one or more processors to determine a recognized behavior for an observed person based on sensor information indicative of a gait of the observed person. The instructions also cause the one or more processors to determine an uncertainty score for the recognized behavior based on a comparison of the recognized behavior to potentially expected behaviors associated with the observed person. The instructions also cause the one or more processors to generate a remedial action instruction based on the uncertainty score.

Example 132 is the non-transitory computer readable medium of example 131, wherein the instructions also cause the one or more processors to determine the comparison based on a model for the potentially expected behaviors

Example 133 is the non-transitory computer readable medium of either of examples 131 or 132, wherein the instructions also cause the one or more processors to determine the potentially expected behaviors based on an identity of the observed person.

Example 134 is the non-transitory computer readable medium of any of examples 131 to 133, wherein the instructions also cause the one or more processors to determine an identity of the observed person based on the gait of the observed person.

Example 135 is the non-transitory computer readable medium of either of examples 133 to 134, wherein the comparison is based on the identity of the observed person.

Example 136 is the non-transitory computer readable medium of any of examples 133 to 135, wherein the identity includes a unique identity of the observed person.

Example 137 is the non-transitory computer readable medium of any of examples 133 to 136, wherein the identity includes a categorical identity of the observed person, wherein the categorical identity describes a category in which the observed person belongs.

Example 138 is the non-transitory computer readable medium of example 137, wherein the category includes at least one of an age group, a gender group, a health level group, an energy level group, a body height group, a body weight group, or a body geometry group.

Example 139 is the non-transitory computer readable medium of any one of examples 131 to 138, wherein the uncertainty score is based on whether the comparison exceeds a predetermined threshold for the recognized behavior.

Example 140 is the non-transitory computer readable medium of any one of examples 131 to 139, wherein the sensor information is indicative of the gait of the observed person over a time period and/or a distance that the observed person moves.

Example 141 is the non-transitory computer readable medium of any one of examples 131 to 140, wherein the instructions also cause the one or more processors to determine the recognized behavior based on a gait analysis of the sensor information as compared to historical gait information.

Example 142 is the non-transitory computer readable medium of any one of examples 131 to 141, wherein the remedial action instruction is further based on a risk level associated with the recognized behavior.

Example 143 is the non-transitory computer readable medium of example 142, wherein the instructions also cause the one or more processors to determine the risk level based on the gait of the observed person and/or the uncertainty score.

Example 144 is the non-transitory computer readable medium of either of examples 142 or 143, wherein the instructions also cause the one or more processors to determine the risk level based on map data indicative of an environment of the observed person.

Example 145 is the non-transitory computer readable medium of any one of examples 142 to 144, wherein the instructions also cause the one or more processors to determine the risk level based on an identity of the observed person.

Example 146 is the non-transitory computer readable medium of any one of examples 131 to 145, wherein the remedial action instruction includes an emergency call instruction, a message display instruction, and/or a robotic movement instruction.

Example 147 is the non-transitory computer readable medium of any one of examples 131 to 146, wherein the instructions also cause the one or more processors to receive identification information about the observed person, determine an expected identity of the observed person based on the gait, determine a deviation between the identification information and the expected identity, and generate an identity verification indicator that confirms the identification information if the deviation is below a predetermined threshold deviation level.

Example 148 is the non-transitory computer readable medium of example 147, wherein the instructions also cause the one or more processors to generate an identity warning if the deviation meets or exceeds the predetermined threshold deviation level.

Example 149 is the non-transitory computer readable medium of any one of examples 131 to 148, wherein the non-transitory computer readable medium is a robot.

Example 150 is the non-transitory computer readable medium of any one of examples 131 to 149, wherein the instructions also cause the one or more processors to receive the sensor information from one or more sensors.

Example 151 is the non-transitory computer readable medium of example 150, wherein the non-transitory computer readable medium includes the one or more sensors.

Example 152 is the non-transitory computer readable medium of example 150, wherein the one or more sensors are external to the non-transitory computer readable medium, wherein the non-transitory computer readable medium further includes a receiver, wherein the instructions also cause the one or more processors to receive via the receiver the sensor information from the one or more sensors.

Example 153 is the non-transitory computer readable medium of example 132, the non-transitory computer readable medium further including a memory, wherein the instructions also cause the one or more processors to store in the memory the model of potentially expected behaviors.

Example 154 is an non-transitory computer readable medium that includes a processor configured to detect a gait of a person using a sensor. The instructions also cause the one or more processors to determine a behavior of the person based on the gait of the person. The instructions also cause the one or more processors to determine a comparison of the behavior to potentially expected behaviors associated with the person and an uncertainty score for the comparison. The instructions also cause the one or more processors to generate a remedial action instruction based on the comparison and the uncertainty score.

Example 155 is the non-transitory computer readable medium of example 154, wherein the instructions also cause the one or more processors to determine the comparison based on a model for the potentially expected behaviors.

Example 156 is the non-transitory computer readable medium of either of examples 154 or 155, wherein the instructions also cause the one or more processors to determine the potentially expected behaviors based on an identity of the person.

Example 157 is the non-transitory computer readable medium of any one of examples 154 to 156, wherein the instructions also cause the one or more processors to determine an identity of the person based on the gait of the person.

Example 158 is the non-transitory computer readable medium of either of examples 156 to 157, wherein the comparison is based on the identity of the person.

Example 159 is the non-transitory computer readable medium of any one of examples 156 to 158, wherein the identity includes a unique identity of the person.

Example 160 is the non-transitory computer readable medium of any one of examples 156 to 159, wherein the identity includes a categorical identity of the person, wherein the categorical identity describes a category in which the person belongs.

Example 161 is the non-transitory computer readable medium of example 160, wherein the category includes at least one of an age group, a gender group, a health level group, an energy level group, a body height group, a body weight group, or a body geometry group.

Example 162 is the non-transitory computer readable medium of any one of examples 154 to 161, wherein the uncertainty score is based on whether the comparison exceeds a predetermined threshold for the behavior.

Example 163 is the non-transitory computer readable medium of any one of examples 154 to 162, wherein the sensor information is indicative of the gait of the person over a time period and/or a distance that the person moves.

Example 164 is the non-transitory computer readable medium of any one of examples 154 to 163, wherein the instructions also cause the one or more processors to determine the behavior based on a gait analysis of the sensor information as compared to historical gait information.

Example 165 is the non-transitory computer readable medium of any one of examples 154 to 164, wherein the remedial action instruction is further based on a risk level associated with the recognized behavior.

Example 166 is the non-transitory computer readable medium of example 165, wherein the instructions also cause the one or more processors to determine the risk level based on the gait of the observed person and/or the uncertainty score.

Example 167 is the non-transitory computer readable medium of either of examples 165 or 166, wherein the instructions also cause the one or more processors to determine the risk level based on map data indicative of an environment of the observed person.

Example 168 is the non-transitory computer readable medium of any one of examples 165 to 167, wherein the instructions also cause the one or more processors to determine the risk level based on an identity of the observed person.

Example 169 is the non-transitory computer readable medium of any one of examples 154 to 168, wherein the remedial action instruction includes an emergency call instruction, a message display instruction, and/or a robotic movement instruction.

Example 170 is the non-transitory computer readable medium of any one of examples 154 to 169, wherein the instructions also cause the one or more processors to receive identification information about the person, determine an expected identity of the person based on the gait, determine a deviation between the identification information and the expected identity, and generate an identity verification indicator that confirms the identification information if the deviation is below a predetermined threshold deviation level.

Example 171 is the non-transitory computer readable medium of example 170, wherein the instructions also cause the one or more processors to generate an identity warning if the deviation meets or exceeds the predetermined threshold deviation level.

Example 172 is the non-transitory computer readable medium of any one of examples 154 to 171, wherein the non-transitory computer readable medium is a robot.

Example 173 is the non-transitory computer readable medium of any one of examples 154 to 172, wherein the instructions also cause the one or more processors to receive the sensor information from one or more sensors.

Example 174 is the non-transitory computer readable medium of example 173, wherein the non-transitory computer readable medium includes the one or more sensors.

Example 175 is the non-transitory computer readable medium of example 173, wherein the one or more sensors are external to the non-transitory computer readable medium, wherein the non-transitory computer readable medium further includes a receiver, wherein the wherein the instructions also cause the one or more processors to receive via the receiver the sensor information from the one or more sensors.

Example 176 is the non-transitory computer readable medium of example 155, the non-transitory computer readable medium further including a memory, wherein the instructions also cause the one or more processors to store in the memory the model of potentially expected behaviors.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising:
a processor configured to:
determine a recognized behavior for an observed person based on sensor information indicative of a gait of the observed person;
determine an uncertainty score for the recognized behavior based on a comparison of the recognized behavior to potentially expected behaviors associated with the observed person; and
generate a remedial action instruction based on the uncertainty score.

2. The device of claim 1, wherein the processor is further configured to determine the comparison based on a model for the potentially expected behaviors.

3. The device of claim 1, wherein the processor is further configured to determine the potentially expected behaviors based on an identity of the observed person.

4. The device of claim 1, wherein the processor is further configured to determine an identity of the observed person based on the gait of the observed person.

5. The device of claim 3, wherein the comparison is based on the identity of the observed person.

6. The device of claim 3, wherein the identity comprises a unique identity of the observed person.

7. The device of claim 3, wherein the identity comprises a categorical identity of the observed person, wherein the categorical identity describes a category in which the observed person belongs.

8. The device of claim 7, wherein the category comprises at least one of an age group, a gender group, a health level group, an energy level group, a body height group, a body weight group, or a body geometry group.

9. The device of claim 1, wherein the uncertainty score is based on whether the comparison exceeds a predetermined threshold for the recognized behavior.

10. The device of claim 1, wherein the sensor information is indicative of the gait of the observed person over a time period and/or a distance that the observed person moves.

11. The device of claim 1, wherein the processor is configured to determine the recognized behavior based on a gait analysis of the sensor information as compared to historical gait information.

12. The device of claim 1, wherein the remedial action instruction is further based on a risk level associated with the recognized behavior.

13. The device of claim 12, wherein the processor is further configured to determine the risk level based on the gait of the observed person or the uncertainty score.

14. The device of claim 12, wherein the processor is further configured to determine the risk level based on map data indicative of an environment of the observed person.

15. The device of claim 12, wherein the processor is further configured to determine the risk level based on an identity of the observed person.

16. The device of claim 1, wherein the remedial action instruction comprises an emergency call instruction, a message display instruction, and/or a robotic movement instruction.

17. The device of claim 1, wherein the processor is further configured to:
receive identification information about the observed person;
determine an expected identity of the observed person based on the gait;
determine a deviation between the identification information and the expected identity; and
generate an identity verification indicator that confirms the identification information if the deviation is below a predetermined threshold deviation level.

18. The device of claim 17, wherein the processor is further configured to generate an identity warning if the deviation meets or exceeds the predetermined threshold deviation level.

19. The device of claim 1, wherein the processor is further configured to receive the sensor information from one or more sensors.

20. The device of claim 2, the device further including a memory configured to store the model.

21. A non-transitory computer readable medium, comprising instructions which, if executed, cause one or more processors to:
detect a gait of a person using a sensor;
determine a behavior of the person based on the gait of the person;
determine a comparison of the behavior to potentially expected behaviors associated with the person and an uncertainty score for the comparison; and
generate a remedial action instruction based on the comparison and the uncertainty score.

22. The non-transitory computer readable medium of claim 21, wherein the instructions further cause the one or more processors to determine the potentially expected behaviors based on a model of historical gait information about the person.

23. The non-transitory computer readable medium of claim 21, wherein the instructions further cause the one or more processors to determine an identity of the person based on the gait of the person.

24. The non-transitory computer readable medium of claim 21, wherein the uncertainty score is based on whether the comparison exceeds a predetermined threshold for the behavior.

25. The non-transitory computer readable medium of claim 21, wherein the instructions further cause to one or more processors to determine the potentially expected behaviors based on an identity of the person.
